(19) United States
(12) Patent Application Publication
(10) Pub. No.: US 2023/0315453 A1
(43) Pub. Date: Oct. 5, 2023

(54) FORWARD CONDITIONAL BRANCH EVENT FOR PROFILE-GUIDED-OPTIMIZATION (PGO)

(71) Applicant: Intel Corporation, Santa Clara, CA (US)

(72) Inventors: Ahmad YASIN, Haifa (IL); Lihu RAPPOPORT, Haifa (IL); Nir TELL, Atlit (IL); Rami BUSOOL, Nof Hagalil (IL); Eyal HADAS, Haifa (IL); Michael CHYNOWETH, Placitas, NM (US); Joseph OLIVAS, Placerville, CA (US); Christopher M. CHRULSKI, Gilbert, AZ (US)

(21) Appl. No.: 17/712,018

(22) Filed: Apr. 1, 2022

(51) Int. Cl. G06F 9/30; G06F 9/38

(52) U.S. Cl. CPC G06F 9/30058; G06F 9/3867

(57) ABSTRACT

An instruction pipeline includes a circuit that can generate a hardware event to indicate conditional branches, including the direction of taken branches. The circuit can generate a forward conditional branch indicator for an opcode when a conditional branch is taken to a forward location from the opcode. The instruction pipeline includes a counter to increment in response to the forward conditional branch indicator, which will indicate a frequency of forward conditional branches for the opcode.

### FIELD

Descriptions are generally related to computer processors, and more particular descriptions are related to performance monitoring of the instruction pipeline.

### BACKGROUND

A forward taken conditional can cause inefficiencies by filling the instruction cache with instructions that are never used and jumped over by the forward taken conditional. Existing PGO (profile-guided-optimization) techniques seek to improve the performance of the pipelined processor by changing the code layout for segments of code that have conditional branches that are regularly taken forward. By changing the code layout, the system seeks to avoid inefficiencies due to forward conditional branches.

Some forward conditional branches are not easily detectable by traditional PGO techniques. For example, realtime operating systems (RTOS) can have timing requirements that will not be met when PGO monitoring operations are performed between instructions to simulate the operation. Thus, an RTOS under simulation may execute very differently than it would in a real runtime environment, resulting in performance monitoring data that is not useful in determining runtime performance.

There are hardware mechanisms to gather perform data, such as with LBR (last branch record) profiling to feed PGO compilation. LBR-based techniques rely on hardware performance monitoring. However, even with performance information, it can be difficult to identify the direction of conditionals taken. Such performance information tends to be dominated by backward branches that end loops.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system with an instruction pipeline with hardware branch events.

FIG. 2 is a block diagram of an example of an instruction pipeline with hardware branch events.

FIG. 3A is a block diagram of an example of a conditional branch event generation circuit.

FIG. 3B is a block diagram of an example of a conditional branch event generation circuit with branch distance filtering.

FIG. 4 is a block diagram of a performance monitoring unit based on conditional branch events.

FIG. 5 is a block diagram of an example of profile guided optimization based on branch events.

FIG. 6 is a flow diagram of an example of a process for performance management based on branch events.

FIGS. 7A-7B illustrate block diagrams of core architectures.

FIG. 8 illustrates an example processor.

FIG. 9 illustrates a first example computer architecture.

FIG. 10 illustrates a second example computer architecture.

FIG. 11 illustrates an example software instruction converter.

Descriptions of certain details and implementations follow, including non-limiting descriptions of the figures, which may depict some or all examples, and well as other potential implementations.

### DETAILED DESCRIPTION

As described herein, an instruction pipeline includes a circuit that can generate a hardware event to indicate conditional branches, including the direction of taken branches. The circuit can generate a forward conditional branch indicator for an opcode when a conditional branch is taken to a forward location from the opcode. The instruction pipeline includes a counter to increment in response to the forward conditional branch indicator, which will indicate a frequency of forward conditional branches for the opcode. A system with an instruction pipeline that can generate such forward-taken conditional branch information can identify conditional branches that are candidates for changes to the code layout.

A system can include a performance monitoring unit (PMU) with an extension for profiling on forward conditional branches. Generation of profile information on forward conditional branches taken can enable achieving additional performance gains when combined with other information in profile-guided-optimizations (PGO) compilers/runtimes or PGO-like systems. Generating event-based information in the instruction pipeline can enable the system to distinguish between forward conditional branches and branches that close loops.

A system can generate a precise performance monitoring (PerfMon) event that counts conditional retired branches that jump in a forward direction. A jump to a forward direction can be referred to as jumping to a target address that is larger than the branch itself. The system can use the event in counting-mode to determine the significance of such branches by determining how often the branch is taken forward, both in terms of pure numbers of takes, and as a comparison to backward taken branches (e.g., a ratio of forward taken conditionals or a percentage of conditionals taken forward). In one example, an analysis environment can execute a precise sampling mode to identify the branches themselves in assembly and source code. In one example, the generated event information can be combined with LBR (last branch record) information for sampling on the event to find common paths that lead to taken execution of a conditional.

In one example, generation of the events in hardware can enable an auto feedback driven optimization (auto-FDO), similar to PGO monitoring. In a system where the assembly or the source of the binary code is not known for PGO optimizations, the system can still provide performance improvements. The executable code could be unknown or unavailable for a variety of reasons, including just-in-time (JIT) compilation, dynamic versioning of the executable, or profile guided optimizations getting dropped for a function or block granularity due small changes in the source code. The system can enable patching the binary on the fly without needing to recompile—the system can simply adjust the layout of the microcode based on branch-level information. The hardware-based branch-level monitoring information enables the system to identify when the compiler missed a branch optimization and adjust it.

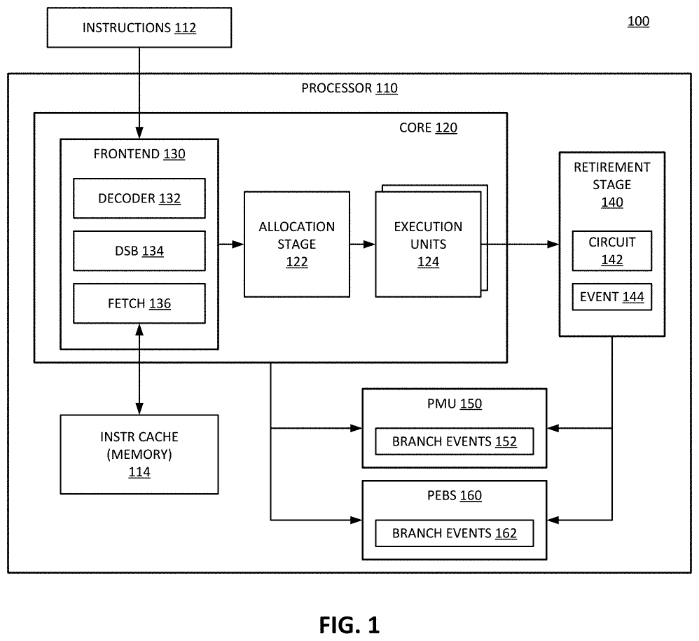

FIG. 1 is a block diagram of an example of a system with an instruction pipeline with hardware branch events. System 100 includes processor 110, which represents a processor of a computer system to execute instructions. Processor includes an instruction pipeline, as indicated by the components represented in system 100. In one example, processor 110 is a pipelined processor that can perform out of order execution. In one example, processor 110 represents a central processing unit (CPU). In one example, processor 110 represents a graphics processing unit (GPU).

Processor 110 can include one or more cores 120. Core 120 represents an individual circuit or unit that can execute instructions. Processor 110 can receive a stream of instructions as represented by instructions 112 for execution by core 120. In one example, core 120 includes frontend 130 to receive and decode instructions 112.

Frontend 130 can include decoder 132 to decode instructions to implement a decode stage of the instruction pipeline. Frontend 130 can include fetch 136 to represent a fetch stage of the instruction pipeline. In one example, fetch 136 accesses instruction (INSTR) cache 114 or other system memory to store or to access an instruction in response to a decode from decoder 132 or an access to decode stream buffer (DSB) 134. Thus, system 100 can include a memory to provide instructions for execution by the instruction pipeline. In one example, frontend 130 includes DSB 134 to buffer instructions 112 from decoder 132. DSB 134 can also be referred to as a uop cache, micro-op cache, or micro-opcode cache.

In one example, frontend 130 includes a branch prediction (not specifically illustrated), which can generate a branch direction prediction. Frontend 130 can determine the branch direction using an immediate value that is part of the instruction opcode. Frontend 130 can infer the direction and assign it to a uop (micro-op or micro-opcode) whether it was just delivered by decoder 132 or stored in DSB 134 for future fetches.

Frontend 130 can provide a decoded instruction or uop to allocation stage 122 to dispatch, allocate, and schedule the instruction for execution. Core 120 includes one or more execution units or compute units, represented by execution units 124. Execution units 124 provide specific computations or operations. Execution units 124 provide the execution stage of the instruction pipeline. After execution, core 120 can pass instructions to retirement stage 140 to be retired. Retirement stage 140 could be referred to as a writeback stage or writeback. The retirement stage of the instruction pipeline.

In one example, retirement stage 140 includes circuit 142 to generate events represented by event 144. Event 144 represents conditional branch events generated by circuit 142. Briefly, circuit 142 represents a hardware mechanism in the instruction pipeline to generate direction information for conditional branches taken during execution. Event 144 enables system 100 to precisely identify how execution of the microcode occurs in the instruction pipeline.

In one example, system 100 includes PMU 150 in processor 110 to track performance information for the instruction pipeline. In one example, PMU 150 tracks branch events 152, which can include information related to or based on event 144. PMU 150 can be implemented by analog circuitry, digital circuitry, or microcode for reconfigurable logic, or any combination of these. In one example, PMU 150 is specific to core 120.

In another example, system 100 may include mechanism for precise event-based sampling (PEBS) 160 to perform processor event-based sampling. In one example, PEBS 160 tracks branch events 162, which can include information related to or based on event 144. In one example, PEBS 160 includes one or more of a call stack, PerfMon framework, instruction pointer, architectural state of processor 110, or register values. PEBS 160 can be implemented by analog circuitry, digital circuitry, or microcode for reconfigurable logic, or any combination of these. In one example, PEBS 160 is specific to core 120.

In one example, system 100 creates event samples or interrupts when a conditional branch retires. Due to precise requirements, event 144 is implemented at retirement to indicate the specific operation branch executed. Traditionally, the branch direction was not known at retirement stage 140. Circuit 142 can enable processor 110 to generate the specific information needed.

In one example, event 144 represents an event that PMU 150 can receive as a BR_INST_RETIRED.COND_TAKEN_FWD (branch instruction retired, conditional taken forward). In one example, processor 110 includes one or more counters to count how often a branch is taken forward. The counter can be implemented as part of circuit 142 in retirement stage 140, as part of PMU 150, or between retirement stage 140 and PMU 150.

In one example, PEBS 160 can generate LBR stream information and combine the information with conditional branch information provided by event 144. Processor 110 can provide the processor event-based sampling as a background process. With the use of hardware events based on circuit 142, system 100 can provide conditional branch information that is one or more orders of magnitude cheaper than traditional approaches. Event 144 can be a hardware event that indicates the direction of the branch taken for a JCC (jump on condition code) or conditional.

In one example, instructions 112 represent instructions provided to processor 110 for execution of a realtime operating system (RTOS) software stack in the instruction pipeline. Even with an RTOS, system 100 can generate conditional branch information based on real operation. Thus, an example of system 100 can provide performance monitoring with hardware-based conditional branch direction information, which can capture useful performance information even for realtime system operation.

The generation of branch taken direction information can be combined with other information in a PGO environment to realize additional gains on already PGO-optimized binaries. Thus, in one example, PEBS 160 can collect LBR information when sampling on event 144 to find the common paths that lead to taken execution of such a conditional. It will be understood that a conditional may not always be taken. Such a process can be referred to as adaptive PEBS, which enables PEBS 160 to collect the LBR with a much-reduced overhead or at higher sampling resolution compared to software-based solutions. In one example, event information from event 144 can be accessed and used in a virtualized context, such as a guest virtual machine, with virtualized PEBS. In one example, PEBS 160 includes PEBS counter snapshotting in a local node operation to collect performance metrics that can be mined for branches with high potential for optimization.

In contrast to traditional systems, system 100 has microarchitecture visibility that is reported by PMU 150. Workloads that exhibit high frontend bound are typically good candidates to gain from PGO optimizations. In contrast to a system that only has post-processing of BR_INST_RETIRED.COND_TAKEN (branch instruction retired—conditional taken) information, system 100 can generate more precise BR_INST_RETIRED.COND_TAKEN_FWD and BR_INST_RETIRED.COND_TAKEN_BWD with specific events to identify the direction of taken conditionals. System 100 can provide such information to a PEBS virtualization runtime environment for PGO analysis.

Whereas traditional static compilers use compiler heuristics to infer edge-profile information such as direction of conditional branches, system 100 can generate events to specifically indicate the branches rather than infer them. Thus, system 100 can account for dynamic conditions (e.g., an if-statement that depends on input parameter or a memory value), in contrast to static compilers that tend to accomplish PGO very early in the stages within their intermediate language, causing them to miss opportunities based on dynamic conditions.

In contrast to interpreter and instrumentation of managed-runtime environments (MRTEs), which induce significant overhead, system 100 can provide conditional branch information without the overhead impact. Furthermore, whereas a simulator, an emulator, or a traditional instrumentation-based compilation tend to require two-phase execution of a program to test operation with different inputs or conditions, system 100 can provide the conditional branch information as part of the normal execution of the pipeline.

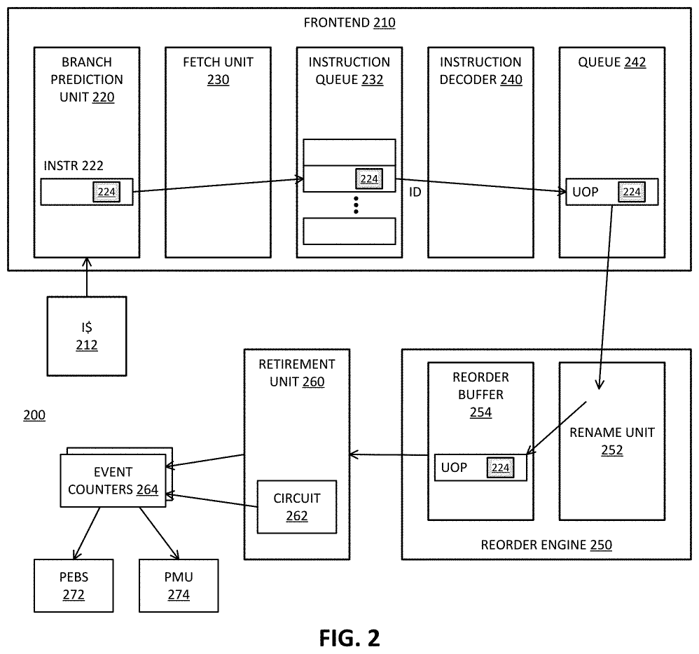

FIG. 2 is a block diagram of an example of an instruction pipeline with hardware branch events. System 200 represents an instruction pipeline in accordance with an example of system 100. System 200 can include portions of a processor such as processor 110 of system 100.

System 200 illustrates the generation of conditional branch event information with a hardware circuit in the instruction pipeline in a system that can also generate other event information. The other event information can be provided by tag information. System 200 illustrates the use of conditional branch information in an instruction pipeline that supports out of order execution.

System 200 includes frontend 210, which can be an example of frontend 130 of system 100. Frontend 210 is represented with branch prediction unit 220, fetch unit 230, instruction queue 232, instruction decoder 240, and decoded instruction queue 242. Frontend 210 can include other components not specifically illustrated.

In one example, frontend 210 loads a cacheline from instruction cache (I$) 212. In the event of a cache miss, system 200 can load the instruction from another memory (not specifically illustrated). Instruction (INSTR) 222 represents the instruction loaded in branch prediction unit 220.

Consider that a cache miss or a predicted execution condition causes system 200 to mark instruction 222 with tag 224. Tag 224 represents an event tag set to a cacheline in the instruction pipeline. The specifics of the event and where and how the tag is set are outside the scope of this description. It will be understood that system 200 can generate event tags for instructions as they move through the instruction pipeline.

In one example, fetch unit 230 reads the cacheline from branch prediction unit 220 (e.g., a buffer or queue of branch prediction unit 220 (not specifically shown). In one example, fetch unit 230 associates any instructions that use the marked cacheline (such as a case where instruction 222 as fetched was incomplete).

In one example, fetch unit 230 sets an entry for instruction 222 with a field or bit, represented by tag 224, in instruction queue 232 when fetch unit 230 writes the instruction to the queue. Instruction decoder 240 can read the instruction from instruction queue 232 through an instruction decode (ID) operation. In one example, instruction decoder 240 identifies tag 224 in instruction 222 in the queue. In one example, decoder 240 creates microoperations for the instruction. Decoder 240 can set the tag in the first resulting microoperation produced for the instruction, such as the UOP (microoperation) illustrated in queue 242. Instruction decoder 240 can write the microoperation, including tag 224, to the queue 242.

In one example, system 200 includes reorder engine 250, which represents an out of order engine to manage the order of operations for execution. In one example, reorder engine 250 is part of the execution unit (such as execution units 124 of system 100) and can generate different execution paths based on the ordering of UOPs. In one example, reorder engine 250 includes rename unit 252, which represents a rename alias table or allocator to read the entry from queue 242. In one example, reorder engine 250 includes reorder buffer 254 to store and track out of order execution. In one example, rename unit passes on tag 224 with the UOP to be stored in reorder buffer 254.

Upon retirement, retirement unit 260 can read the value from reorder buffer 254 and increment counters or other information. In one example, retirement unit 260 includes circuit 262 to generate forward conditional branch indicators. In one example, circuit 262 generates backward conditional branch indicators.

Event counters 264 represent counters for event information. Event counters 264 can include a counter that increments in response to the forward conditional branch indicator to indicate a frequency of forward conditional branches for the opcode. In one example, event counters 264 can include a counter that increments in response to a forward conditional branch not being taken, as indicated by a backward condition branch indicator to indicate a frequency of backward conditional branches for the opcode.

In one example, circuit 262 marks a branch and where it was taken to (i.e., either forward or backward. In one example, circuit 262 can identify the opcode with the indicator to enable event counters 264 to store specific information per opcode, per conditional branch.

In one example, reorder engine 250 tracks indications in queues through the instruction pipeline to pass along the UOP through allocate and rename stages until the opcode eventually reaches retirement. Thus, system 200 can generate tag information that can pass through the instruction pipeline through to retirement to count performance information. On retirement of the UOP, retirement unit 260 can detect whether or not a conditional branch was taken through any known mechanism. Retirement unit 260 can provide the information to circuit 262 to generate the conditional branch taken direction event information.

In one example, retirement unit 260 includes one or more mechanisms to determine whether a jump on conditional code (JCC) was macro-fused with an earlier instruction and can track the JCC appropriately to indicate it to circuit 262. In one example, circuit 262 only operates on JCC opcodes.

In one example, PMU 274 monitors event counters 264 to track values of event counters 264 related to forward conditional branches. In one example, PEBS 272 can signal a PEBS event for event counters 264 related to forward conditional branches. Event counters 264 can indicate information other than forward conditional branches, as represented by the other arrow from retirement unit 260. PMU 274 or PEBS 272, or both, may track events other than forward conditional branch events, or in additional to tracking forward conditional branch events.

In one example, system 200 enables performance monitoring and optimization of the execution of the instruction pipeline based on conditional branch direction information from event data. In one example, an auto FDO system can inspect the number of forward taken branches before and after applying PGO-based optimization and can determine the amount of instruction cache saved per taken branch. An iterative approach on sample code provided gains of up to 20% for one implementation of a real time operating system software stack. Implementations for some graphics software stacks achieved gains over 10%.

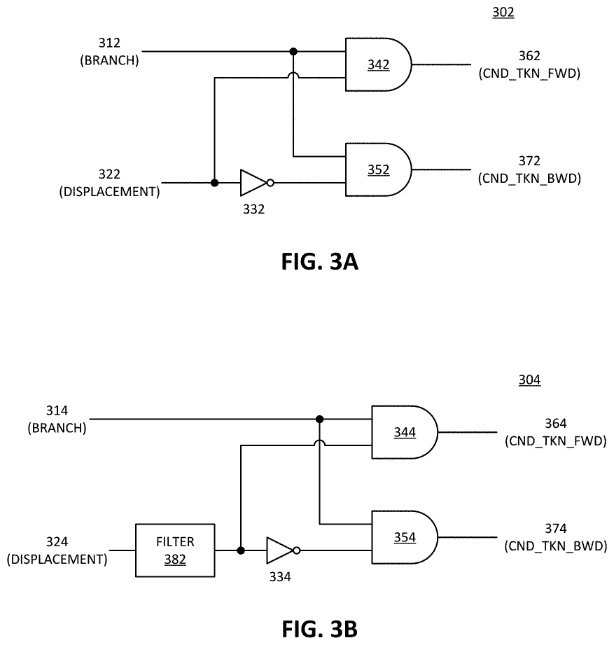

FIG. 3A is a block diagram of an example of a conditional branch event generation circuit. Circuit 302 represents an event generation circuit in accordance with an example of circuit 142 of system 100 or an example of circuit 262 of system 200.

In one example, circuit 302 includes AND gate 342, which receives signal 312 and signal 322 as inputs. In one example, circuit 302 includes AND gate 352, which receives signal 312 and inverted signal 322 as inputs.

Signal 312 represents a branch indication signal, such as an indication that the opcode is a conditional branch (e.g., opcode==JCC). Signal 322 represents a displacement indication, such as a bit of a branch address. In one example, signal 322 is an MSB (most significant bit) of a displacement field. It will be understood that the MSB of the displacement field can indicate whether the branch is forward or reverse. Signal 322 is inverted by inverter 332 to provide to AND gate 352.

In circuit 302, the ANDed combination of branch signal 312 with displacement signal 322 in AND gate 342 produces event 362. Event 362 is a CND_TKN_FWD or .COND_TKN_FWD indicator, or a forward conditional branch indicator. In one example, in response to event 362, the system increments a first counter in response to the forward conditional branch indicator to indicate how often the branch is taken forward for the specific opcode.

The ANDed combination of branch signal 312 with the inverted displacement signal 322 in AND gate 352 produces event 372. Event 372 is a CND_TKN_BWD or .COND_TKN_BWD indicator, or a backward conditional branch indicator. In one example, in response to event 372, the system increments a second counter in response to the backward conditional branch indicator to indicate how often the branch is not taken forward for the specific opcode. Branches taken backward would not generally indicate an opportunity for optimization.

FIG. 3B is a block diagram of an example of a conditional branch event generation circuit with branch count filtering. Circuit 304 represents an event generation circuit in accordance with an example of circuit 142 of system 100 or an example of circuit 262 of system 200.

In one example, circuit 304 includes AND gate 344, which receives signal 314 and signal 324 as inputs. In one example, circuit 304 includes AND gate 354, which receives signal 314 and inverted signal 324 as inputs.

Signal 314 represents a branch indication signal, such as an indication that the opcode is a conditional branch (e.g., opcode==JCC). Signal 324 represents a displacement indication, such as a bit of a branch address. In one example, signal 324 is displacement field information that can be filtered to provide a displacement bit signal. Signal 324 is inverted by inverter 334 to provide to AND gate 354. It will be understood that the displacement bit signal can indicate whether the branch is forward by more than a threshold or more than a minimum distance.

In circuit 304, the ANDed combination of branch signal 314 with displacement signal 324 in AND gate 344 produces event 364. Event 364 is a CND_TKN_FWD or .COND_TKN_FWD indicator, or a forward conditional branch indicator. In one example, in response to event 364, the system increments a first counter in response to the forward conditional branch indicator to indicate how often the branch is taken forward for the specific opcode.

The ANDed combination of branch signal 314 with the inverted displacement signal 324 in AND gate 354 produces event 374. Event 374 is a CND_TKN_BWD or .COND_TKN_BWD indicator, or a backward conditional branch indicator. In one example, in response to event 374, the system increments a second counter in response to the backward conditional branch indicator to indicate how often the branch is not taken forward for the specific opcode. Branches taken backward would not generally indicate an opportunity for optimization.

In one example, circuit 304 includes filter 382, which represents a filter for branch distance. In one example, filter 382 provides a filtering circuit on the value of the displacement field to determine not just if the branch was taken forward, but whether it was taken forward by more than a preset amount. The circuitry can be implemented based on the desired distance and is not illustrated in detail in circuit 304. With filter 382, circuit 304 illustrates a circuit to optionally filter on distance, which can provide more accurate information to include branches only over a certain distance from the opcode.

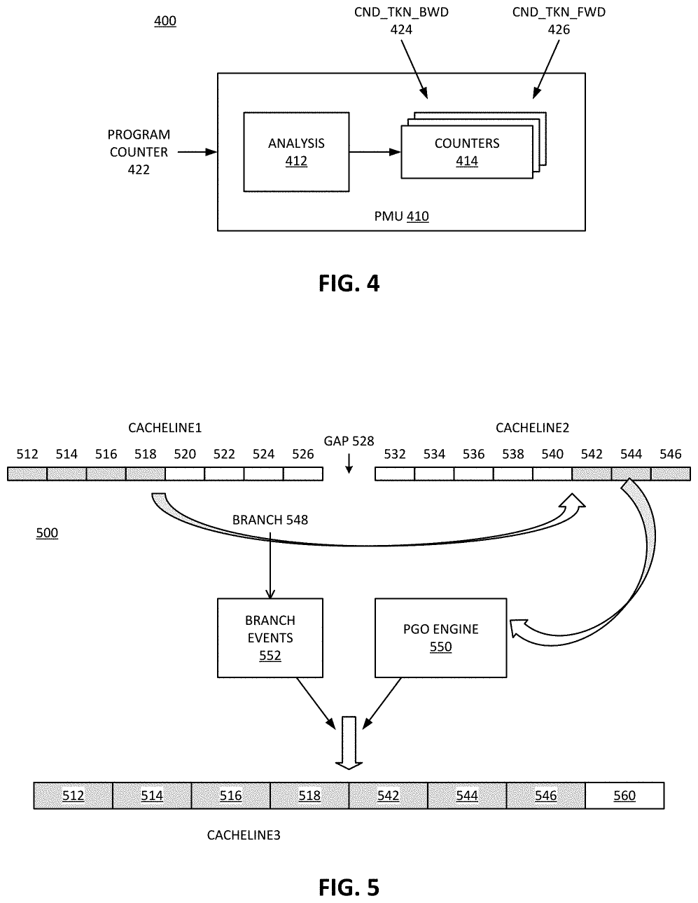

FIG. 4 is a block diagram of a performance monitoring unit based on conditional branch events. System 400 represents a performance monitoring circuit in accordance with an example of system 100 or an example of system 200. While system 400 specifically illustrates PMU 410, it will be understood that the same or similar descriptions can apply to PEBS.

In one example, system 400 includes PMU 410, which generally represents a performance monitoring system. In one example, PMU 410 includes or accesses counters 414. Counters 414 represent counters that track performance indicators for an instruction pipeline of a processor.

In one example, counters 414 include a counter that increments in response to a signal CND_TKN_FWD 426 (referred to as forward indicator 426). In one example, counters 414 include a counter that increments in response to a signal CND_TKN_BWD 424 (referred to as backward indicator 424). In system 400, PMU 410 can associate the counter information for forward indicator 426 and backward indicator 424 (collectively, branch indicators) with program counter 422, to indicate a specific location in the instruction stream for the opcode that resulted in a forward indicator 426.

In one example, PMU 410 includes analysis 412, which represents circuitry or logic in PMU to associate opcode address information with branch indicators. In one example, PMU 410 includes analysis 412 to associate other event information with an opcode. Analysis 412 can enable PMU 410 to determine or to provide information for determining when a forward branch can be optimized by change the code layout.

FIG. 5 is a block diagram of an example of profile guided optimization based on branch events. System 500 illustrates an example with cacheline 1 representing a first cacheline of opcodes, and cacheline 2 representing a second cacheline of opcodes. The two cachelines are not necessarily contiguous in the instruction stream. Gap 528 represents a gap in the execution to switch between cachelines.

Cacheline 1 includes opcodes 512, 514, 516, and 518, which represent opcodes that will normally be executed in continuous order. Opcode 518 represents a JCC or a conditional branch opcode, which will cause the instruction pipeline to normally skip over opcodes 520, 522, 524, and 526 of cacheline 1.

Cacheline 2 includes opcodes 532, 534, 536, 538, and 540 that will normally be skipped due to execution of opcode 518. Cacheline 2 includes opcodes 542, 544, and 546, which will typically follow directly in the execution of opcode 518. Branch 548 represents that opcode 518 generally results in a forward taken branch from opcode 518 to opcode 542.

In one example, system 500 includes PGO engine 550, which represents any hardware or software/firmware logic, or a combination, in a processor system that enables modification of the code layout. In one example, PGO engine 550 receives branch events 552 to inform decisions about code layout optimizations. Branch events 552 can include forward taken conditional branch information generated as a result of branch 548 occurring regularly or consistently in the flow of execution in system 500.

In one example, in response to branch events 552, PGO engine 550 can determine to modify the code layout to generate cacheline 3, which represents a cacheline with opcodes 512, 514, 516, and 518 of original cacheline 1, as well as opcodes 542, 544, and 546 of original cacheline 2. Opcode 560 may or may not be from cacheline 1 or cacheline 2. Opcode 560 represents another opcode PGO engine 550 puts into cacheline 3.

For system 500, if PGO engine 550 only had traditional optimization mechanisms, it would miss the fact that branch 548 normally occurs. The fact that system 500 can generate forward conditional branches taken as hardware events, represented by branch events 548, system 500 can optimize the instruction flow for the instruction pipeline. Thus, the combination of hardware branch events 548 with traditional techniques can enable a system to generate cacheline 3.

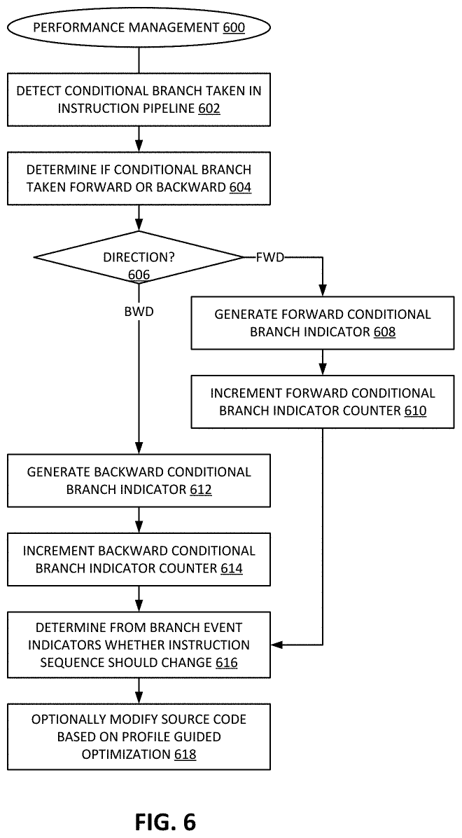

FIG. 6 is a flow diagram of an example of a process for performance management based on branch events. Process 600 represents a process for performance management based on forward conditional branch events in accordance with any system described herein.

In one example, the system detects a conditional branch is taken in an instruction pipeline, at 602. The system includes a circuit to determine if the conditional branch was taken forward to backward, at 604.

If the conditional branch was taken forward, at 606 FWD branch, in one example, the circuit generates a forward conditional branch indicator, at 608. The forward conditional branch indicator can be a hardware event indicator thata system performance management circuitry, such as a PMU or PEBS can utilize. The system can increment a forward conditional branch indicator counter in response to the event, at 610. In one example, the determination of the forward branching is optionally filtered by a minimum distance jumped from the JCC opcode.

In one example, if the conditional branch was taken backward, at 606 BWD branch, in one example, the circuit generates a backward conditional branch indicator, at 612. The system can increment a backward conditional branch indicator counter in response to the event, at 612. If the system includes a forward branching filter, the system can still count backward branches based on jumping backward, and forward branches only for branches that are at least a minimum distance from the opcode. Branches that are forward but not by the minimum distance will not trigger a forward conditional branch indicator, but can also be configured not to trigger a backward conditional branch indicator. Thus, the system could identify three classes of branch, where two are counted and one is not.

In one example, the system determines from branch event indicators (from forward conditional branch indicators in every case, and optionally from backward conditional branch indicators if they are generated), whether the instructions sequence should be changed, at 616. The system can then optionally modify the source code based on profile guided optimization techniques, at 618.

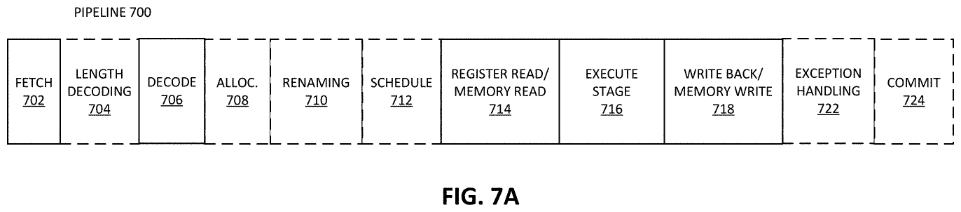

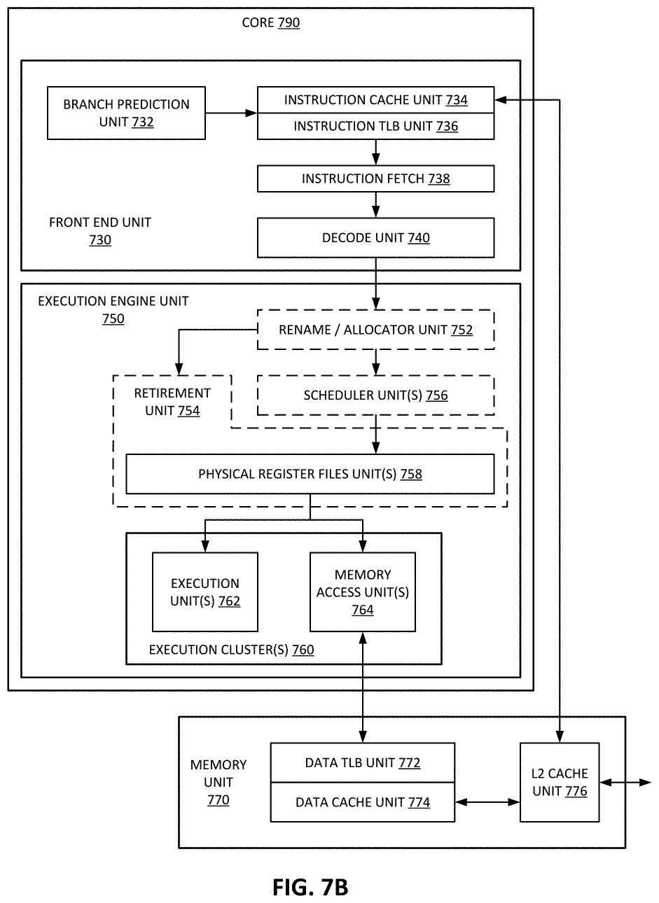

It will be understood that examples may be used in connection with many different processor architectures. FIG. 7A is a block diagram illustrating both an example in-order pipeline and an example register renaming, out-of-order issue/execution pipeline according to various examples. FIG. 7B is a block diagram illustrating both an example of an in-order architecture core and an example register renaming, out-of-order issue/execution architecture core to be included in a processor according to various examples. In various examples, the described architecture may be used to implement a write operation performed by an I/O agent in an I/O domain at a compute domain shared cache hierarchy. The solid lined boxes in FIGS. 7A and 7B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724. Note that as described herein, in a given example a core may include multiple processing pipelines such as pipeline 700.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In some examples, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one example, the physical register file(s) unit 758 includes a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some examples may include a number of execution units dedicated to specific functions or sets of functions, other examples may include only one execution unit or multiple execution units that all perform all functions. The scheduler unit(s) 756, physical register file(s) unit(s) 758, and execution cluster(s) 760 are shown as being possibly plural because certain examples create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain examples are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one example, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the example register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In some examples, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated example of the processor also includes separate instruction and data cache unit 734 and data cache unit 774 and a shared L2 cache unit 776, alternative examples may have a single internal cache for both instructions and data, such as, for example, a level 1 (L1) internal cache, or multiple levels of internal cache. According to some examples, the system may include a combination of an internal cache and an external cache that is external to the core and/or the processor. Alternatively, all of the cache may be external to the core and/or the processor. Note that an example of the execution engine unit 750 described above may place a cache line in the shared L2 cache unit 776 or the L1 internal cache in a placeholder state in response to a request for ownership of the cache line from an I/O agent in an I/O domain thereby reserving the cache line for the performance of a write operation by the I/O agent using examples herein.

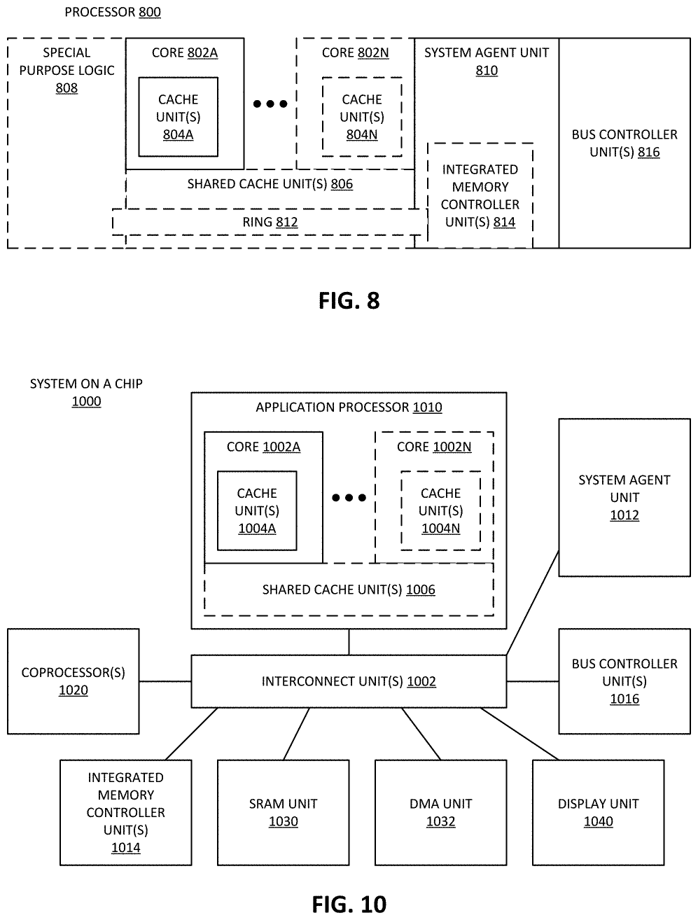

FIG. 8 is a block diagram of a processor 800 that may have more than one core, may have an integrated memory controller, and may have integrated graphics according to various examples. The solid lined boxes in FIG. 8 illustrate a processor 800 with a single core 802A, a system agent 810, a set of one or more bus controller units 816, while the optional addition of the dashed lined boxes illustrates an alternative processor 800 with multiple cores 802A-N, a set of one or more integrated memory controller unit(s) in the system agent unit 810, and a special purpose logic 808, which may perform one or more specific functions.

Thus, different implementations of the processor 800 may include: 1) a CPU with a special purpose logic being integrated graphics and/or scientific (throughput) logic (which may include one or more cores), and the cores 802A-N being one or more general purpose cores (e.g., general purpose in-order cores, general purpose out-of-order cores, a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, BiCMOS, CMOS, or NMOS.

The memory hierarchy includes one or more levels of cache units 804A-N within the cores, a set or one or more shared cache units 806, and external memory (not shown) coupled to the set of integrated memory controller units 814. The set of shared cache units 806 may include one or more mid-level caches, such as L2, L3, L4, or other levels of cache, a last level cache (LLC), and/or combinations thereof. While in one example a ring based interconnect unit 812 interconnects the special purpose 808, the set of shared cache units 806, and the system agent unit 810/integrated memory controller unit(s) 814, alternative examples may use any number of well-known techniques for interconnecting such units.

The system agent unit 810 includes those components coordinating and operating cores 802A-N. The system agent unit 810 may include for example a power control unit (PCU) and a display unit. The PCU may be or include logic and components needed for regulating the power state of the cores 802A-N and the special purpose logic 808. The display unit is for driving one or more externally connected displays.

The cores 802A-N may be homogenous or heterogeneous in terms of architecture instruction set; that is, two or more of the cores 802A-N may be capable of execution of the same instruction set, while others may be capable of executing only a subset of that instruction set or a different instruction set. In some examples, a cache line in one of the shared cache units 806 or one of the core cache units 804A-804N may be placed in a placeholder state in response to a cache line ownership request received from an I/O agent in an I/O domain thereby reserving the cache line for the performance of a write operation by the I/O agent as described herein.

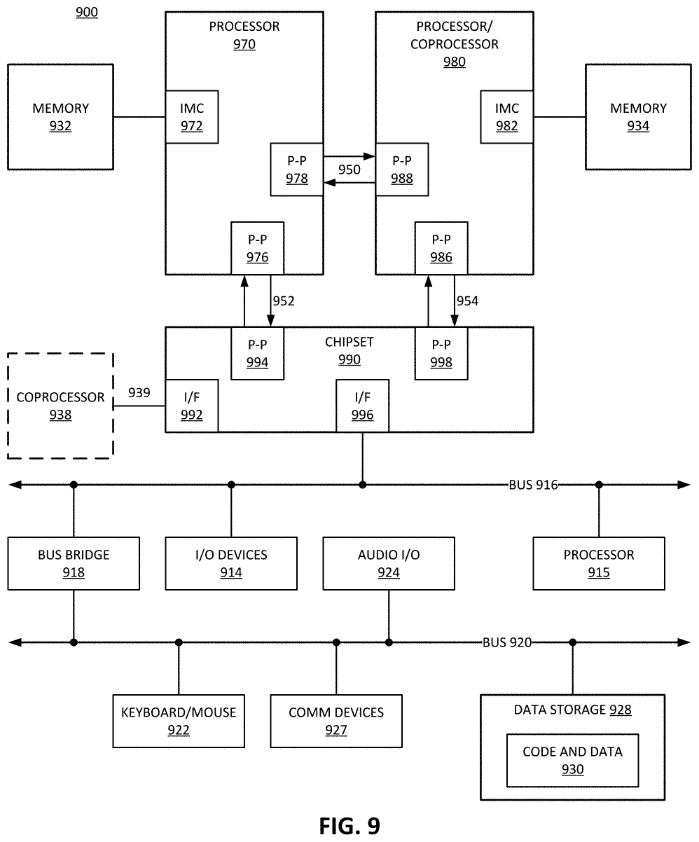

FIGS. 9-11 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a large variety of systems or electronic devices capable of incorporating a processor and/or other execution logic as disclosed herein are generally suitable.

Referring now to FIG. 9 illustrates a first example computer architecture. FIG. 9, shown is a block diagram of a first more specific example system 900. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 900.

Processors 970 and 980 are shown including integrated memory controller (IMC) units 972 and 982, respectively. Processor 970 also includes, as part of its bus controller units, point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, integrated memory controllers (IMCs) 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 939 with interface circuit 992. According to some examples, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors yet connected with the processors via P-P interconnect, such that either or both processors' local cache information may be stored in the shared cache if a processor is placed into a low power mode. In some examples, a cache line in the shared cache or the local cache may be placed in a placeholder state in response to an ownership request from an I/O agent in an I/O domain thereby reserving the cache line for the performance of a write operation by the I/O agent.

Chipset 990 may be coupled to a first bus 916 via an interface 996. In some examples, first bus 916 may be a Peripheral Component Interconnect (PCI) bus, or a bus such as a PCI Express bus or another third generation I/O interconnect bus, although the scope is not so limited.

As shown in FIG. 9, various I/O devices 914 may be coupled to first bus 916, along with a bus bridge 918 which couples first bus 916 to a second bus 920. According to some examples, one or more additional processor(s) 915, such as coprocessors, high-throughput MIC processors, GPGPU's, accelerators (such as, e.g., graphics accelerators or digital signal processing (DSP) units), field programmable gate arrays, or any other processor, are coupled to first bus 916. In one example, second bus 920 may be a low pin count (LPC) bus. Various devices may be coupled to a second bus 920 including, for example, a keyboard and/or mouse 922, communication devices 927 and a storage unit 928 such as a disk drive or other mass storage device which may include instructions/code and data 930, in one example. Further, an audio I/O 924 may be coupled to the second bus 920. Note that other architectures are possible. For example, instead of the point-to-point architecture of FIG. 9, a system may implement a multi-drop bus or other such architecture.

Referring now to FIG. 10, shown is a block diagram of a SoC 1000 in accordance with an example. Dashed lined boxes are optional features on more advanced SoCs. In FIG. 10, an interconnect unit(s) 1002 is coupled to: an application processor 1010 which includes a set of one or more cores 1002A-N (including constituent cache units 1004A-N); shared cache unit(s) 1006; a system agent unit 1012; a bus controller unit(s) 1016; an integrated memory controller unit(s) 1014; a set or one or more coprocessors 1020 which may include integrated graphics logic, an image processor, an audio processor, and a video processor; a static random access memory (SRAM) unit 1030; a direct memory access (DMA) unit 1032; and a display unit 1040 for coupling to one or more external displays. In one example, the coprocessor(s) 1020 include a special-purpose processor, such as, for example, a network or communication processor, compression engine, GPGPU, a high-throughput MIC processor, embedded processor, or the like. In various examples, a cache line in a constituent cache unit 1004A-N or in a shared cache unit 1006 may be placed in a placeholder state in response to an ownership request for a cache line from an I/O agent in an I/O domain thereby reserving the cache line for the performance of a write operation by the I/O agent.

Examples of the mechanisms disclosed herein may be implemented in hardware, software, firmware, or a combination of such implementation approaches. Various examples may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

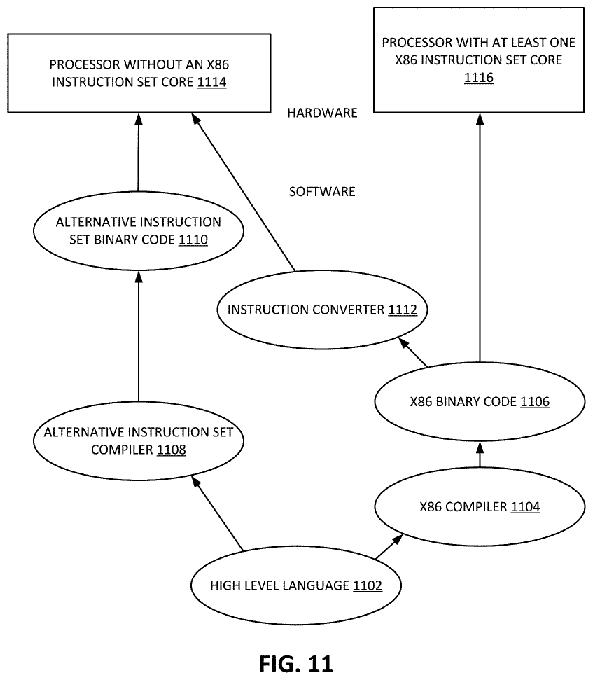

FIG. 11 is a block diagram contrasting the use of a software instruction converter to convert binary instructions in a source instruction set to binary instructions in a target instruction set according to various examples. In the illustrated example, the instruction converter is a software instruction converter, although alternatively the instruction converter may be implemented in software, firmware, hardware, or various combinations thereof.

FIG. 11 shows a program in a high level language 1102 may be compiled using an x86 compiler 1104 to generate x86 binary code 1106 that may be natively executed by a processor with at least one x86 instruction set core 1116. The processor with at least one x86 instruction set core 1116 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core.

The x86 compiler 1104 represents a compiler that is operable to generate x86 binary code 1106 (e.g., object code) that can, with or without additional linkage processing, be executed on the processor with at least one x186 instruction set core 1116. Similarly, FIG. 11 shows the program in the high level language 1102 may be compiled using an alternative instruction set compiler 1108 to generate alternative instruction set binary code 1110 that may be natively executed by a processor without at least one x86 instruction set core 1114 (e.g., a processor with cores that execute the MIPS instruction set of MIPS Technologies of Sunnyvale, CA and/or that execute the ARM instruction set of ARM Holdings of Sunnyvale, CA). The instruction converter 1112 is used to convert the x86 binary code 1106 into code that may be natively executed by the processor without an x86 instruction set core 1114. This converted code is not likely to be the same as the alternative instruction set binary code 1110 because an instruction converter capable of this is difficult to make; however, the converted code will accomplish the general operation and be made up of instructions from the alternative instruction set. Thus, the instruction converter 1112 represents software, firmware, hardware, or a combination thereof that, through emulation, simulation, or any other process, allows a processor or other electronic device that does not have an x86 instruction set processor or core to execute the x86 binary code 1106.

Example 1 is an apparatus for performance management, comprising: a circuit in an instruction pipeline to generate a forward conditional branch indicator for an opcode when a conditional branch is taken to a forward location from the opcode; and a counter to increment in response to the forward conditional branch indicator to indicate a frequency of forward conditional branches for the opcode.

Example 2 is an apparatus in accordance with Example 1, wherein the circuit comprises an AND operation of a conditional branch selection with a displacement bit to determine when the conditional branch is taken to the forward location.

Example 3 is an apparatus in accordance with Example 2, wherein the circuit comprises an AND operation of the conditional branch selection with an inverted displacement bit to determine when the conditional branch is taken to a backward location.

Example 4 is an apparatus in accordance with any of Examples 1-3, wherein the circuit is to generate the forward conditional branch indicator only when the conditional branch is taken to the forward location at least a distance from the opcode.

Example 5 is an apparatus in accordance with any of Examples 1-4, wherein the instruction pipeline comprises an instruction pipeline for a realtime operating system (RTOS) software stack.

Example 6 is an apparatus in accordance with any of Examples 1-5, wherein the counter is accessed through a performance monitoring unit (PMU).

Example 7 is an apparatus in accordance with any of Examples 1-6, wherein the counter is accessed through a virtual machine with a virtualized precise event-based sampling (PEBS) monitoring system.

Example 8 is an apparatus in accordance with Example 7, wherein the PEBS is to combine information from the counter with LBR (last branch record) data to detect common paths in code of the instruction pipeline.

Example 9 is a method for performance management, comprising: detecting a forward conditional branch is taken in an instruction pipeline to a forward location from an opcode; generating a forward conditional branch indicator for the opcode in response to detecting the conditional branch is taken; and incrementing a forward conditional branch indicator count in response to the forward conditional branch indicator to indicate a frequency of forward conditional branches for the opcode.

Example 10 is a method in accordance with Example 9, wherein generating the forward conditional branch indicator comprises filtering the forward conditional branch indicator based on the conditional branch being taken at least a minimum forward distance from the opcode.

Example 11 is a method in accordance with any of Examples 9-10, wherein detecting the forward condition branch is taken comprises execution of an instruction pipeline for a realtime operating system (RTOS) software stack.

Example 12 is a method in accordance with any of Examples 9-11, further comprising: accessing a counter through a virtual machine with a virtualized precise event-based sampling (PEBS) monitoring system.

Example 13 is a method in accordance with any of Examples 9-12, further comprising: accessing a counter through a performance monitoring unit (PMU).

Example 14 is a method in accordance with any of Examples 9-13, wherein when forward conditional branch is not taken, incrementing a backward conditional branch indicator, and further comprising: comparing the forward conditional branch indicator to the backward conditional branch indicator to determine a percentage of taken forward conditionals.

Example 15 is a computer system, comprising: a memory to provide instructions for execution; and a processor to execute instructions from the memory, the processor including: an instruction pipeline; a circuit to generate a forward conditional branch indicator for an opcode when a conditional branch is taken to a forward location from the opcode; and a counter to increment in response to the forward conditional branch indicator to indicate a frequency of forward conditional branches for the opcode.

Example 16 is a computer system in accordance with Example 15, wherein the circuit is to generate the forward conditional branch indicator only when the conditional branch is taken to the forward location at least a distance from the opcode.

Example 17 is a computer system in accordance with any of Examples 15-16, wherein the processor comprises a central processing unit (CPU).

Example 18 is a computer system in accordance with any of Examples 15-16, wherein the processor comprises a graphics processing unit (GPU).

Example 19 is a computer system in accordance with any of Examples 15-18, wherein the processor includes a precise event-based sampling (PEBS) monitoring system or a performance monitoring unit (PMU) to access the counter.

Example 20 is a computer system in accordance with any of Examples 15-19, wherein the counter comprises a first counter, and wherein the circuit is to generate a backward conditional branch indicator for the opcode when the conditional branch is taken to a backward location from the opcode, and the processor further comprising: a second counter to increment in response to the backward conditional branch indicator.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. An apparatus, comprising:
a circuit in an instruction pipeline of a processor to generate a forward conditional branch indicator for an opcode when a conditional branch is taken to a forward location from the opcode; and
a counter to increment in response to the forward conditional branch indicator to indicate a frequency of forward conditional branches for the opcode.

2. The apparatus of claim 1, wherein the circuit comprises an AND operation of a conditional branch selection with a displacement bit to determine when the conditional branch is taken to the forward location.

3. The apparatus of claim 2, wherein the circuit comprises an AND operation of the conditional branch selection with an inverted displacement bit to determine when the conditional branch is taken to a backward location.

4. The apparatus of claim 1, wherein the circuit is to generate the forward conditional branch indicator only when the conditional branch is taken to the forward location at least a distance from the opcode.

5. The apparatus of claim 1, wherein the instruction pipeline comprises an instruction pipeline for a realtime operating system (RTOS) software stack.

6. The apparatus of claim 1, wherein the counter is accessed through a performance monitoring unit (PMU).

7. The apparatus of claim 1, wherein the counter is accessed through a virtual machine with a virtualized precise event-based sampling (PEBS) monitoring system.

8. The apparatus of claim 7, wherein the PEBS includes a buffer to store combined information from the counter and last branch record (LBR) data, to detect common paths in code of the instruction pipeline.

9. A method, comprising:
detecting a forward conditional branch is taken in an instruction pipeline of a processor to a forward location from an opcode;
generating a forward conditional branch indicator for the opcode in response to detecting the conditional branch is taken; and
incrementing a forward conditional branch indicator count in response to the forward conditional branch indicator to indicate a frequency of forward conditional branches for the opcode.

10. The method of claim 9, wherein generating the forward conditional branch indicator comprises filtering the forward conditional branch indicator based on the conditional branch being taken at least a minimum forward distance from the opcode.

11. The method of claim 9, wherein detecting the forward condition branch is taken comprises execution of an instruction pipeline for a realtime operating system (RTOS) software stack.

12. The method of claim 9, further comprising:
accessing a counter through a virtual machine with a virtualized precise event-based sampling (PEBS) monitoring system.

13. The method of claim 9, further comprising:
accessing a counter through a performance monitoring unit (PMU).

14. The method of claim 9, wherein when forward conditional branch is not taken, incrementing a backward conditional branch indicator, and further comprising:
comparing the forward conditional branch indicator to the backward conditional branch indicator to determine a percentage of taken forward conditionals.

15. A computer system, comprising:
a memory to provide instructions for execution; and
a processor to execute instructions from the memory, the processor including:
an instruction pipeline;
a circuit to generate a forward conditional branch indicator for an opcode when a conditional branch is taken to a forward location from the opcode; and
a counter to increment in response to the forward conditional branch indicator to indicate a frequency of forward conditional branches for the opcode.

16. The computer system of claim 15, wherein the circuit is to generate the forward conditional branch indicator only when the conditional branch is taken to the forward location at least a distance from the opcode.

17. The computer system of claim 15, wherein the processor comprises a central processing unit (CPU).

18. The computer system of claim 15, wherein the processor comprises a graphics processing unit (GPU).

19. The computer system of claim 15, wherein the processor includes a performance monitoring unit (PMU) to access the counter.

20. The computer system of claim 15, wherein the counter comprises a first counter, and wherein the circuit is to generate a backward conditional branch indicator for the opcode when the conditional branch is taken to a backward location from the opcode, and the processor further comprising:
a second counter to increment in response to the backward conditional branch indicator.
